(19) United States
(12) Patent Application Publication
(10) Pub. No.: US 2010/0070158 A1
(43) Pub. Date: Mar. 18, 2010

(54) FUEL INJECTION DEVICE

(76) Inventors: Yoshinori Futonagane, Shizuoka-ken (JP); Fumihiro Okumura, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/513,541

(22) PCT Filed: Nov. 6, 2007
(86) PCT No.: PCT/IB2007/003364

§ 371 Date: May 5, 2009

(30) Foreign Application Priority Data
Nov. 7, 2006 (JP) 2006-302148

(51) Int. Cl. F02D 41/40; F02M 45/02; F02M 45/08

(52) U.S. Cl. 701/105; 239/548

(57) ABSTRACT

A fuel injection device (1) includes a fuel injection valve (2) that injects fuel, and is provided with a first nozzle hole (9) and the second nozzle hole (10), which are controlled independently of each other to inject the fuel. The fuel injection device further includes a controller (5) that performs a deposit removal fuel injection in accordance with an amount of deposits accumulated in the first nozzle hole and/or the second nozzle hole. The deposit removal fuel injection injects fuel to remove the deposits.

### BACKGROUND OF THE INVENTION

1. Field of the Invention

The invention relates to a fuel injection device of an internal combustion engine.

2. Description of the Related Art

In a fuel injection valve having a first nozzle hole and a second nozzle hole, that injects a fuel directly into a cylinder, generally, one of the nozzle holes is selected to inject the fuel based on the engine operation state or fuel injection amount. Thus, one of the first nozzle hole and the second nozzle hole is not sometimes used. When the fuel is injected through the first nozzle hole, not the second nozzle hole, deposits are likely to accumulate in the second nozzle hole. In order to prevent the second nozzle hole from being clogged with deposits, Japanese Patent Application Publication No. 2002-310042 (JP-A-2002-310042) describes that, when such a fuel injection (through only the first nozzle hole) continues for a predetermined period, the fuel injection is forcibly performed through the second nozzle hole.

If the deposits accumulate in the nozzle hole, fuel atomization quality is degraded. As a result, the fuel flow amount decreases, the exhaust is degraded, and output power decreases. Accordingly, as described in JP-A-2002-310042, it is necessary to periodically inject fuel to remove the deposits. Meanwhile, a kind of fuel injection valve having a first nozzle hole and a second nozzle hole opens and closes the first nozzle hole and the second nozzle hole independently. Such kind of fuel injection valve is provided with, for example, an outer needle that opens and closes the first nozzle hole located on an upstream side of the nozzle body, and an inner needle that opens and closes the second nozzle hole located on the downstream side of the nozzle body, and independently controls the outer needle and the inner needle to inject fuel. Such a fuel injection valve sometimes injects fuel through only the second nozzle hole, while the first nozzle hole is not used. In this case, deposits accumulate in the first nozzle hole.

### SUMMARY OF THE INVENTION

Accordingly, the present invention provides a fuel injection device that properly remove deposits accumulated on the fuel injection valve having a first nozzle hole and a second nozzle hole, which are controlled independently of each other to inject fuel.

An aspect of the present invention provides a fuel injection device that includes a fuel injection valve that injects fuel, and is provided with a first nozzle hole and a second nozzle hole that are controlled independently of each other to inject the fuel. The fuel injection device further includes a controller that controls a deposit removal fuel injection through the fuel injection valve in accordance with an amount of deposits accumulated in at least one of the first nozzle hole and the second nozzle hole. The deposit removal fuel injection is an injection performed to remove the accumulated deposits. In the fuel injection valve having the first nozzle hole and the second nozzle hole that are controlled independently of each other to inject fuel, a state in which one of the first nozzle hole and the second nozzle hole is not used, may occur. In other words, deposits may accumulate in either one of the first nozzle hole and the second nozzle hole. Therefore, the deposit amount of each nozzle hole is controlled independently. Further, the number of deposit removal fuel injections is reduced and the fuel injection amount and the injection timing are set appropriately, in consideration of drivability, noise and vibration (NV), reduction in fuel mileage, and the like, as much as possible. In addition, a deposit increment amount may be calculated for each nozzle hole, to perform deposit removal fuel injections more appropriately.

The deposit amount may be determined in accordance with a deposit increment amount and/or a deposit decrement amount that are/is calculated based on an engine operation state, to obtain the deposit amount as accurate as possible. Further, at least one of an ambient temperature of the fuel injection valve, an injection pattern, and a fuel flow rate in the nozzle holes, which affect the accumulation and detachment of deposits, may be reflected in the deposit amount.

The fuel injection device may perform a pilot injection and an after-injection, in addition to a main injection, to achieve an appropriate fuel (amount or dispersion) in the combustion chamber. These types of injections are appropriately performed through the first nozzle hole and the second nozzle hole, to avoid the accumulation of deposits in each nozzle hole. As a result, deposits are removed by these injections, which are performed to operate the internal combustion engine appropriately, and thus unnecessary fuel consumption is avoided. Accordingly, reduction in fuel mileage due to the deposit removal fuel injection is minimized. Further, because the injection timing of the deposit removal fuel injection substantially corresponds to the injection timing of a normal injection, drivability and NV are not degraded significantly. In addition, when the main injection, pilot injection or after-injection as the deposit removal fuel injection is performed through a nozzle hole different from that used in the normal main injection, normal pilot injection or the like, the degradation of drivability and NV is reduced by adjusting the injection amount and injection timing. In doing this, the injection control may be performed in consideration of the difference in diameter between the first nozzle hole and the second nozzle hole.

Besides the pilot injection, a pre-injection may be performed before the main injection in the injection control of the fuel injection valve. Similarly, besides the after-injection, a post-injection may be performed after the main injection. For simplicity, however, every injection performed before the main injection is called a pilot injection, and every injection performed after the main injection is called an after-injection in this specification. Thus, the pilot injection sometimes includes a pre-injection, and the after-injection sometimes includes a post-injection. Further, in this specification, “increment” sometimes indicates “addition” and “decrement” sometimes indicates “subtraction.”

As described above, according the aspect of the present invention, the fuel injection valve has the first nozzle hole and the second nozzle hole that are controlled independently of each other to inject fuel. The deposit removal fuel injection is performed in accordance with the deposit amount in the first nozzle hole and the second nozzle hole. As a result, deposits in both the first nozzle hole and the second nozzle hole are removed. Accordingly, the reduction in atomization at the time of fuel injection, reduction in fuel mileage, or the like is reduced.

### BRIEF DESCRIPTION OF THE DRAWINGS

The foregoing and further objects, features and advantages of the invention will become apparent from the following description of example embodiments with reference to the accompanying drawings, wherein like numerals are used to represent like elements and wherein:

FIG. 1 is a view schematically shows a construction of a fuel injection device according an embodiment of the present invention;

FIGS. 2A, 2B and 2C are views illustrating injection modes of the fuel injection device according to the embodiment;

FIG. 3 is a flowchart illustrating a part of a control process of the fuel injection device according to the embodiment;

FIG. 4 is a flowchart illustrating a part of the control process of the fuel injection device according to the embodiment;

FIG. 5 is a flowchart illustrating a part of the control process of the fuel injection device according to the embodiment;

FIG. 6 is a view illustrating an example of a map to determine the injection modes;

FIG. 7 is a timing chart showing a normal injection pattern of the first mode;

FIG. 8 is a timing chart showing an example of an injection pattern of a second nozzle hole removal mode;

FIG. 9 is a timing chart showing another example of the injection pattern of the second nozzle hole removal mode;

FIG. 10 is a timing chart showing another example of the injection pattern of the second nozzle hole removal mode;

FIG. 11 is a timing chart showing another example of the injection pattern of the second nozzle hole removal mode;

FIG. 12 is a timing chart showing another example of the injection pattern of the second nozzle hole removal mode;

FIG. 13 is a timing chart showing a normal injection pattern of the second mode;

FIG. 14 is a timing chart showing an example of an injection pattern of a first nozzle hole removal mode;

FIG. 15 is a timing chart showing another example of an injection pattern of a first nozzle hole removal mode;

FIG. 16 is a timing chart showing another example of an injection pattern of a first nozzle hole removal mode;

FIG. 17 is a timing chart showing another example of an injection pattern of a first nozzle hole removal mode;

FIG. 18 is a view illustrating a map to obtain a decrement amount of the deposit in the second nozzle hole removal mode;

FIG. 19 is a view illustrating a map to obtain a decrement amount of the deposit in the first nozzle hole removal mode;

FIG. 20 is a view schematically illustrating a fuel injection device according to another embodiment of the present invention.

### DETAILED DESCRIPTION OF EMBODIMENTS

Hereinafter, embodiments of the present invention are described in detail with reference to the drawings.

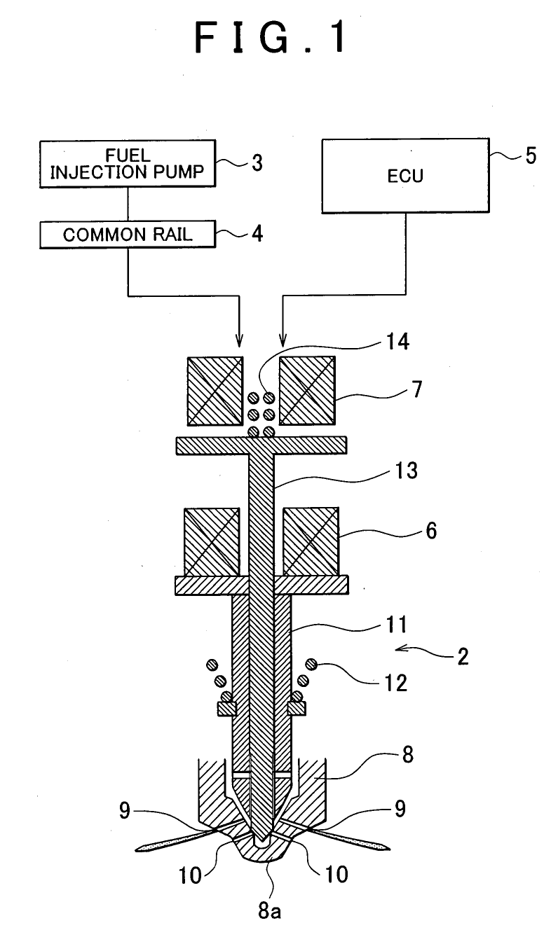

FIG. 1 is a schematic view illustrating a fuel injection device 1 according an embodiment of the present invention. The fuel injection device 1 includes a fuel injection valve 2, the distal end of which is seen in enlarged cross-section shown in FIG. 1. The fuel injection valve 2 is attached to each cylinder of an unshown engine, and injects fuel into a combustion chamber of the engine. A fuel pressurized by a fuel injection pump 3 is supplied to the fuel injection valve 2 via a common rail 4.

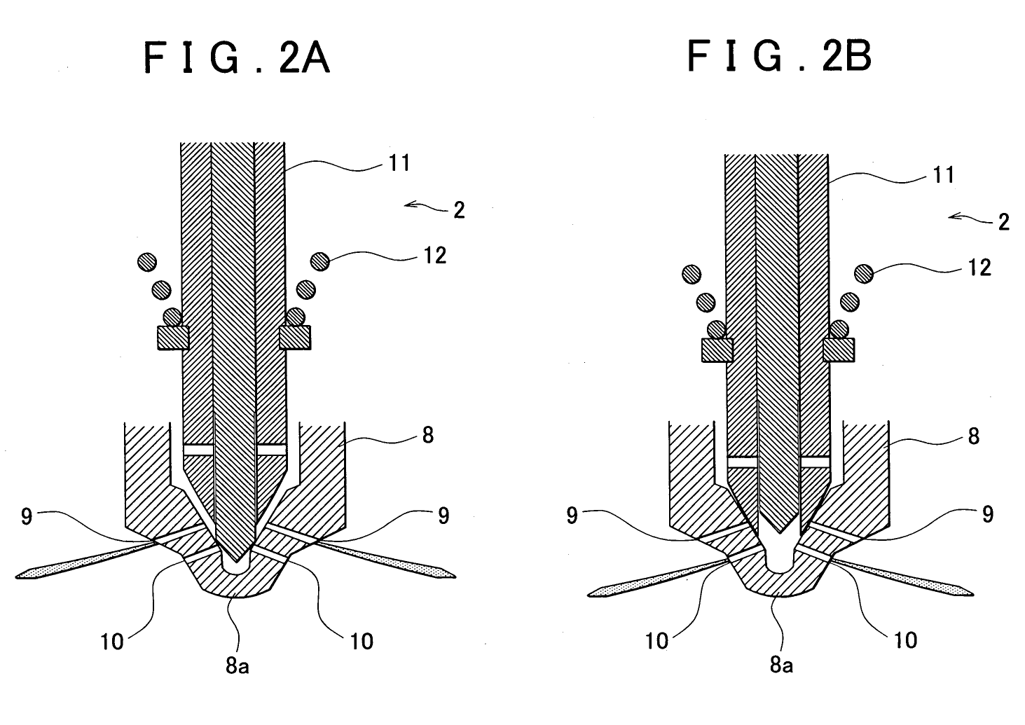

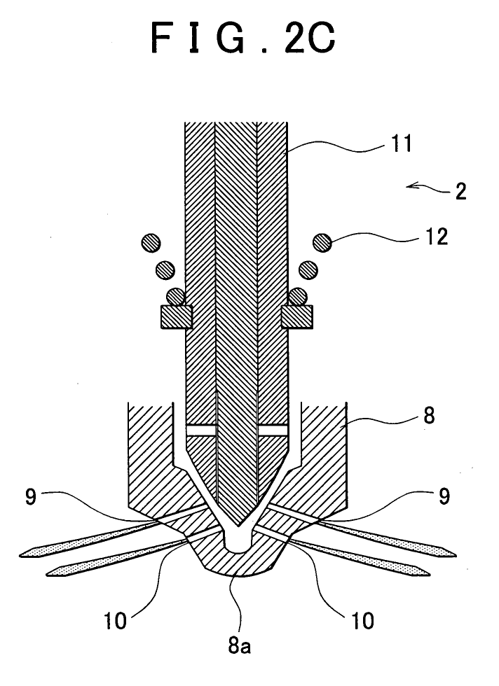

The fuel injection valve 2 is provided with nozzle holes that are located at a distal end 8a of a nozzle body 8 and are spaced from each other in the fuel flow direction. In other words, the fuel injection valve 2 has a first nozzle hole 9 on the upstream side and a second nozzle hole 10 on the downstream side. The diameter of the second nozzle hole 10 is greater than the diameter of the first nozzle hole 9. An outer needle 11 is inserted in the nozzle body 8 and is slidable in the longitudinal direction of the fuel injection valve 2, and blocks fuel injection through the first nozzle hole 9. A first actuator 6 pulls the outer needle 11 in the upstream direction. The outer needle 11 is provided with a spring 12 that presses the outer needle 11 in the downstream direction. The outer needle 11 is hollow and an inner needle 13 is inserted in the outer needle 11. The inner needle 13 blocks the fuel injection through the second nozzle hole 10. A second actuator 7 pulls the inner needle 13 in the upstream direction. Further, the inner needle 13 is provided with a spring 14 that presses the inner needle 13 in the downstream direction. The first actuator 6 and the second actuator 7 are driven, by the commands from the ECU (Electronic Control Unit) 5 to open and close the fuel injection valve 2. Thus, the fuel injection valve 2 has the first nozzle hole 9 and the second nozzle hole 10 that are controlled independently of each other to inject fuel. The fuel injection valve 2 is switchable among three injection modes (as shown in FIGS. 2A-2C), i.e. the first mode, the second mode and the third mode, based on the conditions of the first nozzle hole 9 and the second nozzle hole 10. In the first mode (FIG. 2A), fuel is injected only through the first nozzle hole 9. In the second mode (FIG. 2B), fuel is injected only through the second nozzle hole 10. In the third mode (FIG. 2C), fuel is injected through both the first nozzle hole 9 and the second nozzle hole 10.

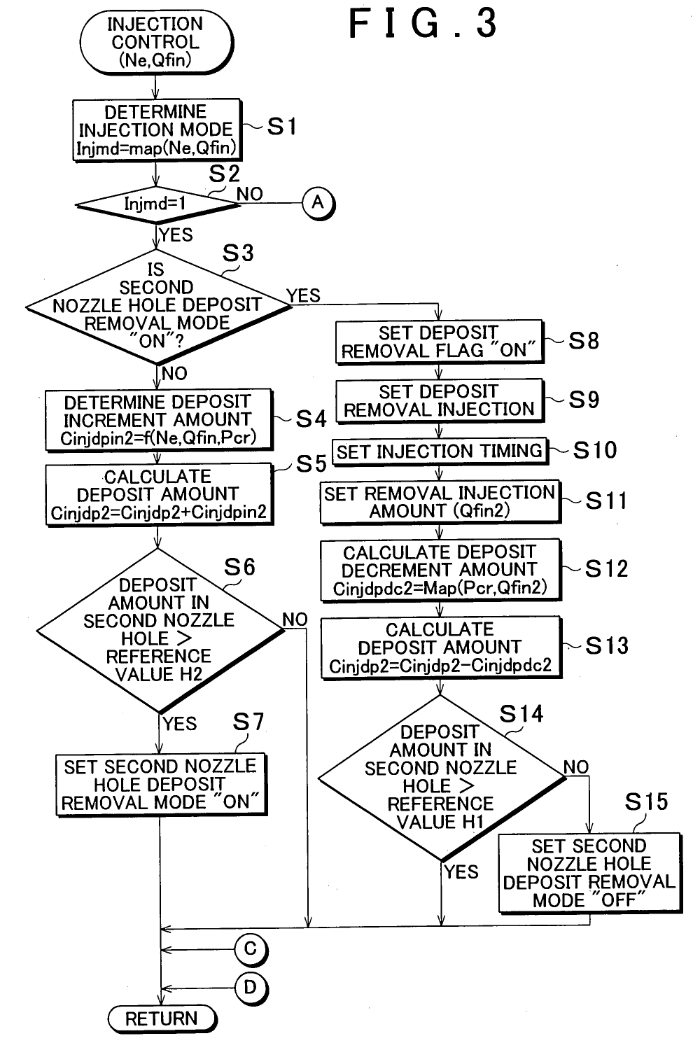

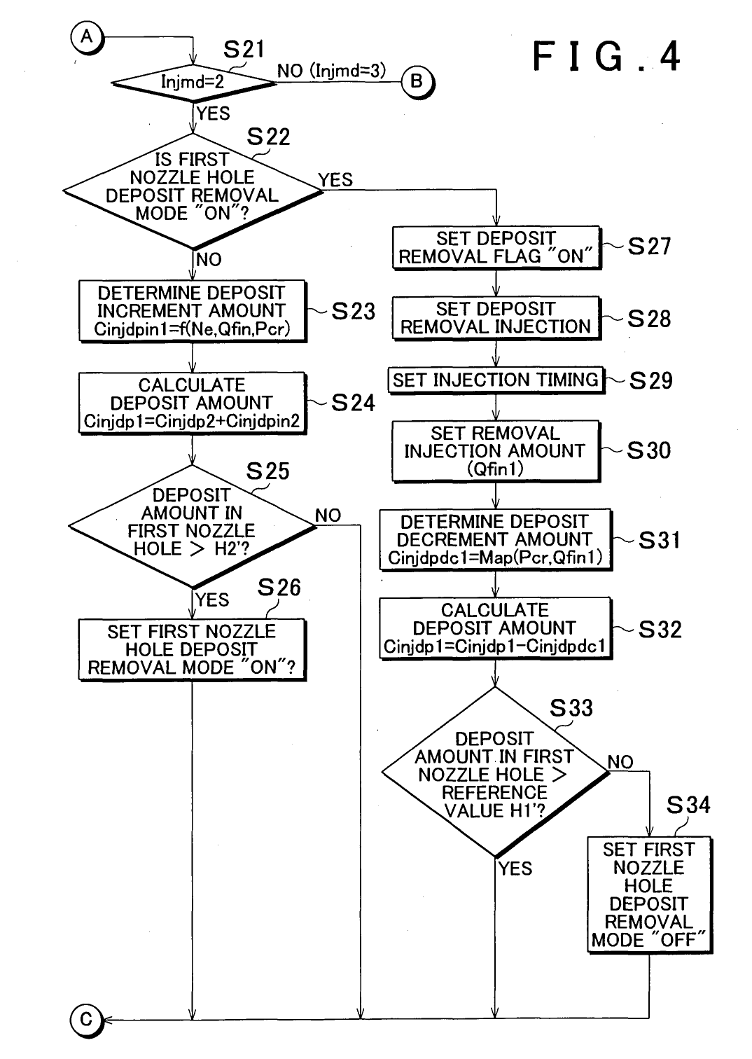

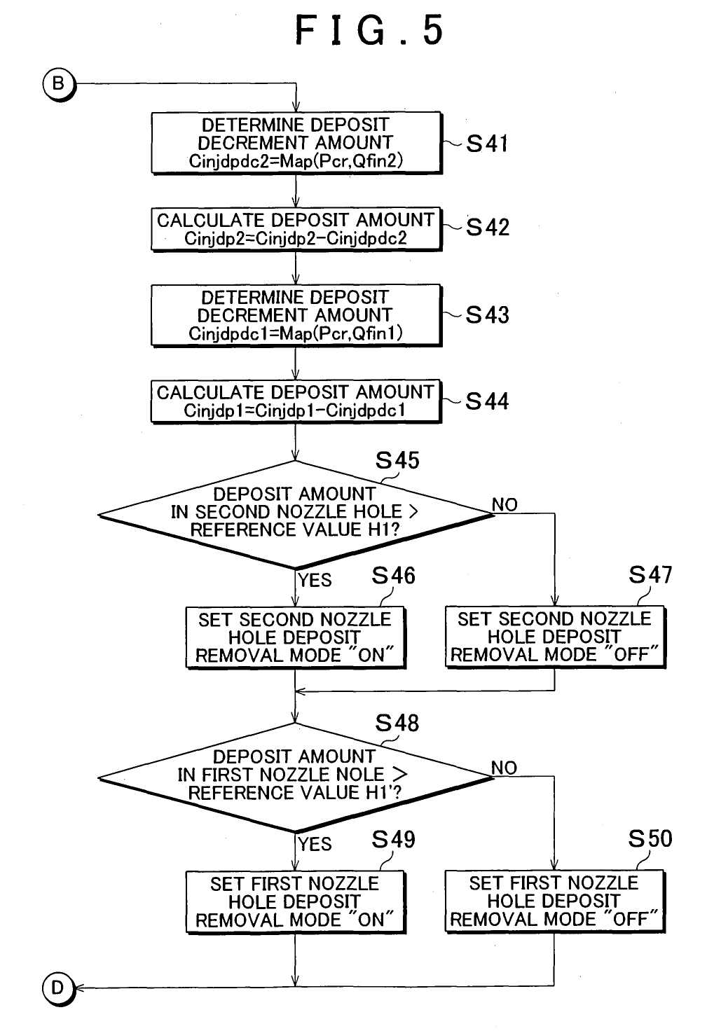

The ECU 5 performs deposit removal fuel injections in the injection modes differently from each other. The deposit removal fuel injection is performed in accordance with the amount of deposits accumulated in the first nozzle hole 9 and the second nozzle hole 10. The deposit removal fuel injection means that fuel is injected to remove deposits accumulated in the injection holes. An injection control of the fuel injection device 1 will be explained hereinafter with reference to the flowchart shown in FIGS. 3 to 5. FIGS. 3 to 5 show a single flowchart divided into three. The symbol “A” in FIG. 3 connects to the symbol “A” in FIG. 4. Similarly, the symbol “B” in FIG. 4 connects to the symbol “B” in FIG. 5. Further, the symbol “C” in FIG. 3 connects to the symbol “C” in FIG. 4, and the symbol “D” in FIG. 3 connects to the symbol “D” in FIG. 5.

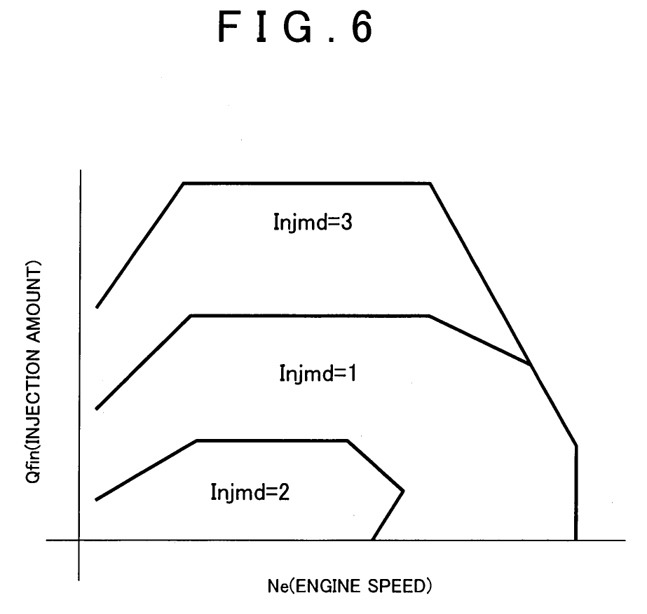

First, the ECU 5 determines the injection mode in step S1. The injection mode is determined based on an injection mode determination map shown in FIG. 6. The injection mode (Injmd) is calculated from an engine speed (Ne) and a fuel injection amount (Qfin). In step S2, it is determined whether the injection mode is the first mode (Injmd=1). If it is determined that the injection mode is the first mode, i.e., the fuel is injected only through the first nozzle hole 9 as shown in FIG. 2A, deposits are likely to accumulate in the second nozzle hole 10. Accordingly, the control process proceeds to step S3, in which it is determined whether the injection control is in a mode to remove the deposits in the second nozzle hole 10. If the determination in step S3 is negative, the control process proceeds to step S4. In step S4, a deposit increment amount is calculated.

The deposit increment amount (Cinjdpin2) of the second nozzle hole 10 is calculated as follows. Generally, the accumulation rate of deposits is likely to be affected by a nozzle ambient temperature (ambient temperature of the fuel injection valve), an injection pattern, and a fuel flow rate in the nozzle holes. Therefore, these factors are considered when the deposit increment amount is calculated. In other words, the following facts are reflected in the calculation of the deposit increment amount. That is, the deposits accumulate more, as the nozzle ambient temperature is higher; when the flame position in the combustion chamber changes according to the injection pattern, the nozzle ambient temperature is likely to change; and the deposits accumulate more, as the fuel flow rate in the nozzle hole is slower. The fuel flow rate in the nozzle hole may be denoted by using a common rail pressure (Pcr) and the fuel injection amount (Qfin). Thus, the deposit increment amount (Cinjdpin2) may be given as the following function using the above as parameters: Cinjdpin2=f(Ne, Qfin, Pcr). More specifically, it may expressed as f(Ne, Qfin, Pcr)=C1×Ne+C2×Qfin+C3×Pcr, where C1, C2, C3 are fitness factors.

The deposit increment amount (Cinjdpin2) of the second nozzle hole 10 thus calculated in step S4 is added to the current deposit amount (Cinjdp2) to obtain a new deposit amount (Cinjdp2). The new deposit amount (Cinjdp2) is stored in the RAM (Random Access Memory) in the ECU 5.

Then, the ECU 5 determines, in step S6, whether the deposit amount (Cinjdp2) calculated in step S5 is greater than a reference value H2. The reference value H2 is a value that defines criteria for determining whether the deposit removal fuel injection is performed through the second nozzle hole 10. If the determination in step S6 is affirmative, then the control process proceeds to step S7, in which the mode is switched to the mode to remove deposits in the second nozzle hole 10.

After the process of step S7, the control process returns to the beginning and repeats from step S1. When the process subsequently reaches step S3, the determination in step S3 is affirmative. If the determination in step S6 is negative, then the control process returns to the beginning. Then, the process repeats from step S1 until the determination in step S6 becomes affirmative.

If the determination in step S3 is affirmative, the control process performed by the ECU 5 proceeds to step S8, in which a flag indicating that the deposit removal mode is active is set ON. The deposit removal mode means that the deposit removal fuel injection is performed. The control process subsequently proceeds to step S9, step S10, and step S11. In step S9, the deposit removal fuel injection is set. In step S10, the injection timing is set. Further, in step S11, fuel injection amount Qfin2 of the deposit removal fuel injection is determined. Thus, conditions of the deposit removal fuel injection are determined.

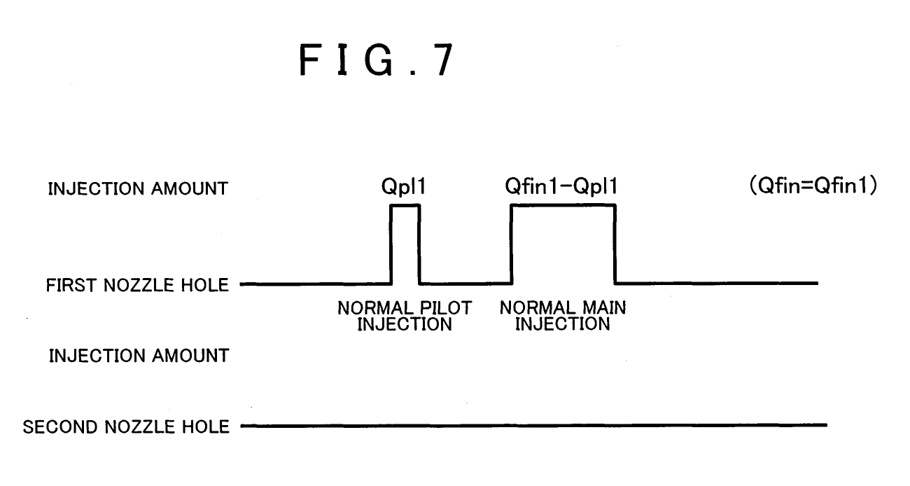

The processes performed in step S9 to step S11 will be described in detail. First, the injection pattern shown in FIG. 7 will be explained. FIG. 7 shows a state (timing chart) of normal fuel injection when the injection mode is the first mode (Injmd=1). In the first mode, all the injections are performed through the first nozzle hole 9. Thus, both the normal pilot injection and the normal main injection are performed through the first nozzle hole 9. No fuel is injected through the second nozzle hole 10. Here, Qfin=Qfin1, where Qfin is the total injection amount through the fuel injection valve 2 in one cycle, and Qfin1 is the injection amount through the first nozzle hole 9 in one cycle. Further, if the normal pilot injection amount is denoted by Qpl1, the normal main injection amount is denoted by Qfin1-Qpl1. Such a normal injection is performed when the deposit removal flag is OFF.

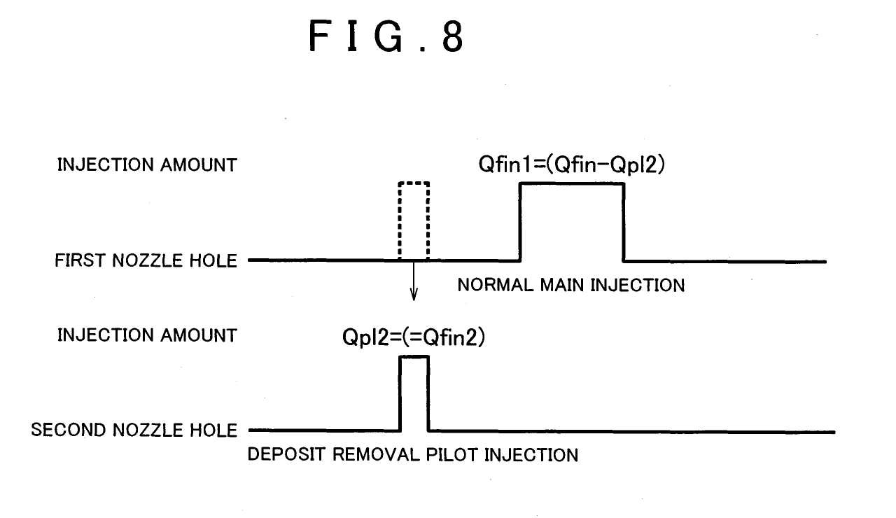

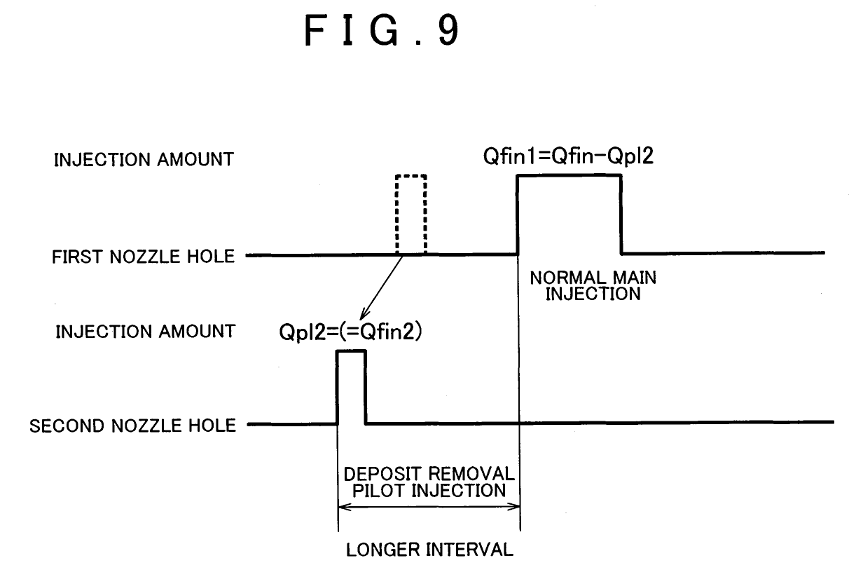

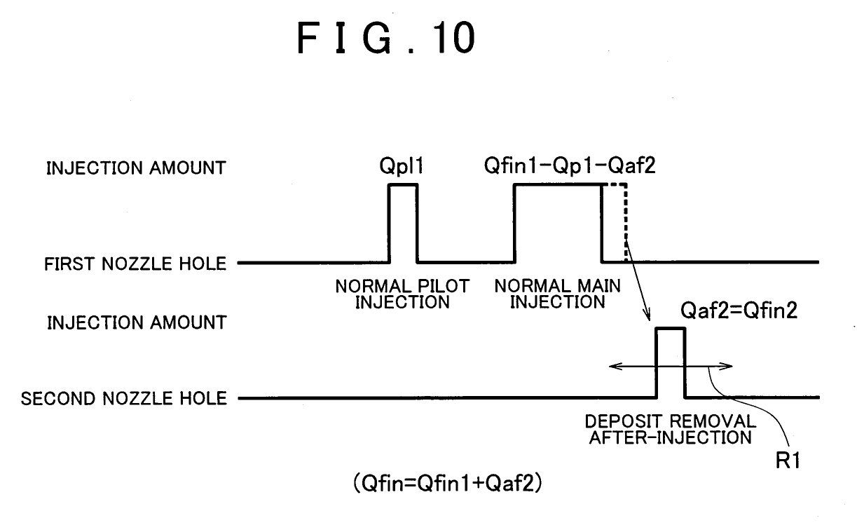

If the deposit removal flag is set ON, then the mode is switched from the normal injection to the deposit removal injection mode as shown in FIG. 8. In the injection pattern shown in FIG. 8, a pilot injection (“deposit removal pilot injection”) is performed through the second nozzle hole 10 to remove the deposits therein, instead of the normal pilot injection through the first nozzle hole 9. Such a fuel injection through the second nozzle hole 10 removes deposits accumulated in the second nozzle hole 10. In FIG. 8, the injection timing of the deposit removal pilot injection is the same as the injection timing of the normal pilot injection as shown in FIG. 7. In addition, the both injection amounts are the same. Thus, the relationship denoted by Qpl1=Qpl2 (=Qfin2) is established. Accordingly, the total injection amount Qfin1 through the first nozzle hole 9 is denoted by Qfin1=Qfin−Qpl2, where Qpl2 is the injection amount of the deposit removal pilot injection through the second nozzle hole 10. Thus, because the injection amount in one cycle of the deposit removal mode is the same as that in one cycle of the normal injection, the influence on the drivability is minimized.

Further, when the deposit removal pilot injection is performed through the second nozzle hole 10, instead of the normal pilot injection performed through the first nozzle hole 9, the time interval between the deposit removal pilot injection and the normal main injection may be set longer than the time interval between the normal pilot injection and the normal main injection. This is because the diameter of the second nozzle hole 10 is greater than the diameter of the first nozzle hole 9. By doing this, the exhaust degradation (emission degradation) may be reduced.

Alternatively, as shown in FIG. 10, a portion of the normal main injection performed through the first nozzle hole 9 in the normal injection may be separated (or reduced) and the separated (or reduced) amount of fuel may be injected through the second nozzle hole 10 as an after-injection to remove deposits therein (“deposit removal after-injection”). In other words, a portion Qaf2 of the normal main injection may be injected through the second nozzle hole 10. The injection timing of the deposit removal after-injection may be adjusted in the time range denoted by the reference numeral R1 in FIG. 10, in consideration of the influences by performing a portion of the main injection through the second nozzle hole 10, such as the degradation of drivability or emission, or the like.

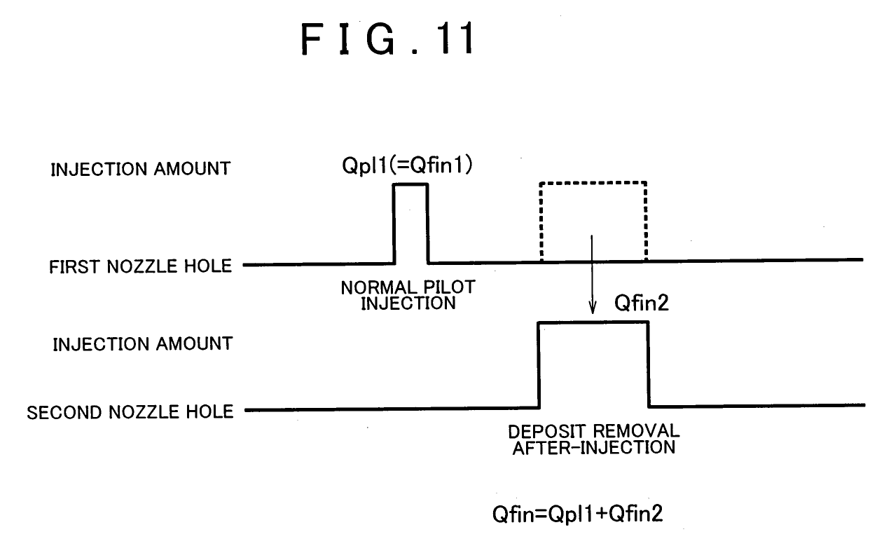

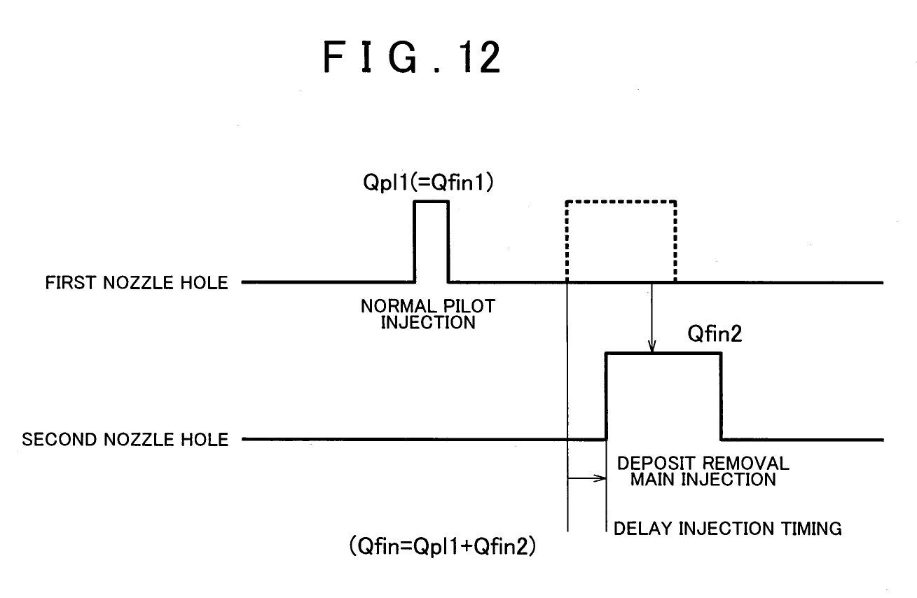

Further, as shown in FIG. 11, the entire normal main injection performed in the normal fuel injection through the first nozzle hole 9 may be replaced with a main injection performed through the second nozzle hole 10 to remove deposits therein (“deposit removal main injection”). When the normal main injection is replaced with the deposit removal main injection in this way, the injection timing of the deposit removal main injection may be delayed, as compared to the injection timing of the normal main injection. By doing so, the emission degradation resulting from the fact that the diameter of the second nozzle hole 10 to perform the deposit removal main injection is greater than the diameter of the first nozzle hole 9, is reduced.

As described above, by injecting fuel through the second nozzle hole 10, the deposits accumulated in the second nozzle hole 10 are removed.

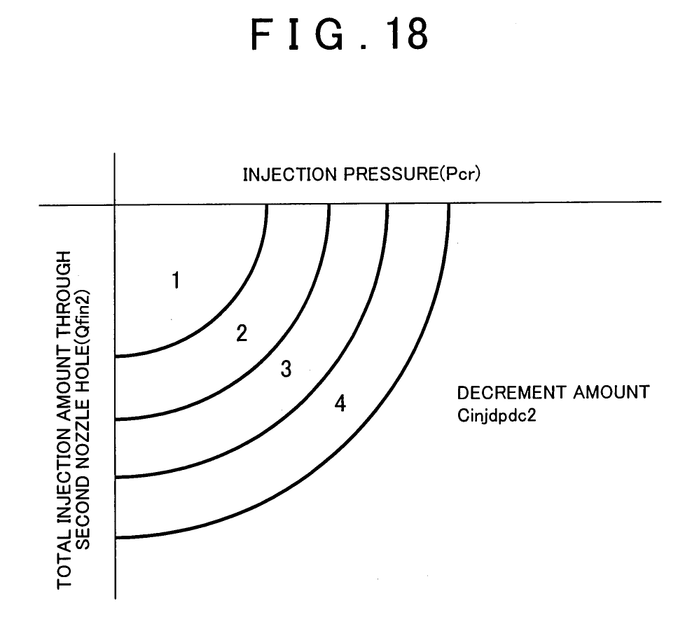

As described above, after the ECU 5 determines the conditions of the fuel injection to remove the deposits in the second nozzle hole, the control process proceeds to step S12, in which the ECU 5 determines the deposit decrement amount Cinjdpdc2, which is a deposit amount removed by the deposit removal fuel injection through the second nozzle hole. The deposit decrement amount Cinjdpdc2 is determined based on the map shown in FIG. 18. By using the map, the deposit decrement amount Cinjdpdc2 is obtained from the total fuel injection amount Qfin2 of the fuel injected through the second nozzle hole 10 to remove deposits and the fuel injection pressure Pcr. This is because, during the removal of the deposits accumulated in a nozzle hole, the recovery rate of the injection amount and the injection pressure of the fuel injected through the nozzle hole changes from the state where the atomization has been degraded by the accumulated deposits. In this embodiment, the four regions 1 to 4 are provided in the map shown in FIG. 18, and the deposit decrement amount Cinjdpde2 corresponding to each region is determined.

In step S13, the deposit decrement amount Cinjdpdc2 determined in step S12 is subtracted from the current deposit amount Cinjdp2 to calculate a new deposit amount Cinjdp2.

Subsequently, the ECU 5 determines in step S14 whether the deposit amount Cinjdp2 calculated in step S13 is greater than a reference value H1. The reference value H1 is a value that defines criteria for determining whether deposit removal fuel injection through the second nozzle hole 10 is stopped. If the determination in step S14 is affirmative, the control process returns to the beginning and repeats from step S1. On the contrary, if the determination in step S14 is negative, the control process proceeds to step S15, in which the deposit removal mode of the second nozzle hole is set OFF, and then returns to the beginning. The process repeats from step S1 thereafter.

Next, the case where the determination in step S2 is negative will be explained. If the injection mode is not the first mode (Injmd=1), the control process proceeds to step S21. In step S21, it is determined whether the injection mode is the second mode (Injmd=2). If it is determined that the injection mode is the second mode, i.e., the fuel is injected only through the second nozzle hole 10, deposits are likely to accumulate in the first nozzle hole 9. Therefore, the control process proceeds to step S22, in which it is determined whether the injection control is in a mode to remove the deposits in the first nozzle hole. If the determination in step S22 is negative, the control process proceeds to step S23, in which the deposit increment amount is calculated.

The deposit increment amount Cinjdpin1 of the first nozzle hole 9 is calculated as follows. Generally, the accumulation rate of deposits is likely to be affected by the nozzle ambient temperature, the injection pattern, and the fuel flow rate in the nozzle holes. Therefore, these factors are considered when the deposit increment amount is calculated. This process corresponds to that in step S4, and the deposit increment amount Cinjdpin1 is given by the following function: Cinjdpin1=F(Ne, Qfin, Pcr). More specifically, it may be expressed as f(Ne, Qfin, Pcr)=C1×Ne+C2×Qfin+C3×Pcr, where C1, C2, C3 are fitness factors.

The deposit increment amount Cinjdpin1 of the first nozzle hole 9 thus calculated in step S23 is added to the current deposit amount Cinjdp1 in step S24 to calculate a new deposit amount Cinjdp1. The calculated new deposit amount Cinjdp1 is stored in the RAM (Random Access Memory) in the ECU 5.

Subsequently, the ECU 5 determines in step S25 whether the deposit amount Cinjdp1 is greater than the reference value H2′. The reference value H2′ is a value that defines criteria for determining whether deposit removal fuel injection is performed through the first nozzle hole 9. If the determination in step S25′ is affirmative, the control process proceeds to step S26, in which the mode is switched to the mode to remove deposits in the first nozzle hole 9.

After the process of step S26, the control process returns to the beginning and repeats from step S1. When the process subsequently reaches step S22, the determination in step S22 is affirmative. If the determination in step S25 is negative, then the control process directly returns to the beginning, and repeats from step S1 until the determination in step S25 becomes affirmative.

If the determination in step S22 is affirmative, the control process performed by the ECU 5 proceeds to step S27, in which a flag indicating that the deposit removal mode is active is set ON. The deposit removal mode means that the deposit removal fuel injection is performed. The control process subsequently proceeds to step S28, step S29, and step S30. In step S28, the deposit removal fuel injection is set. In step S29, the injection timing is set. Further, in step S30, fuel injection amount Qfin1 of the deposit removal fuel injection is determined. Thus, conditions of the deposit removal fuel injection are determined.

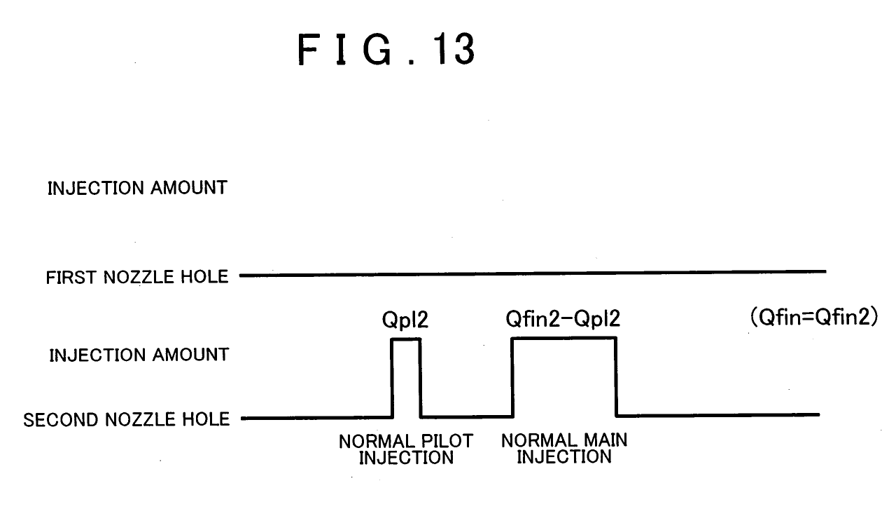

The processes performed in step S28 to step S30 will be described in detail. First, the injection pattern shown in FIG. 13 will be explained. FIG. 13 shows a state (timing chart) of a normal fuel injection when the injection mode is the second mode (Injmd=2). In the second mode, all the injections are performed through the second nozzle hole 10. Thus, both the normal pilot injection and the normal main injection are performed through the second nozzle hole 10. No fuel is injected through the first nozzle hole 9. Here, Qfin=Qfin2, where Qfin is the total injection amount through the fuel injection valve 2 in one cycle, and Qfin2 is the injection amount through the second nozzle hole 10 in one cycle. Further, if the normal pilot injection amount is denoted by Qpl2, the normal main injection amount is denoted by Qfin2-Qpl2. Such a normal injection is performed when the deposit removal flag is OFF.

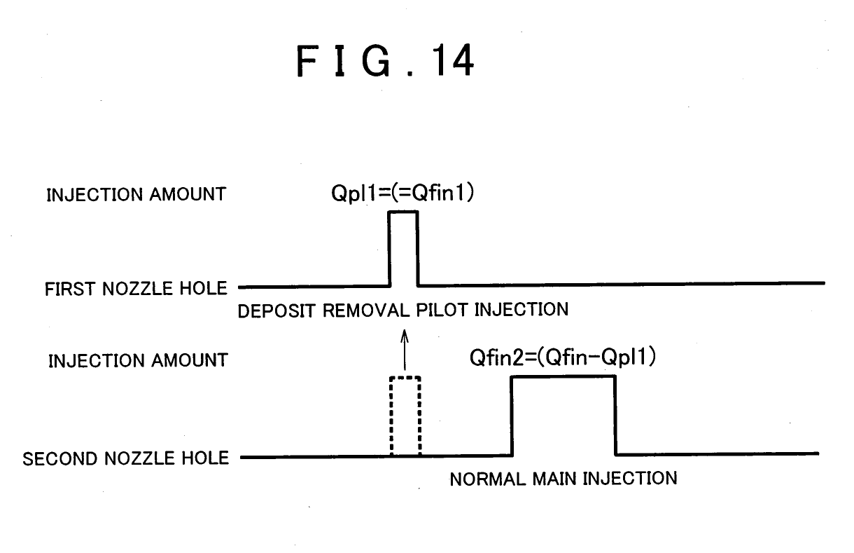

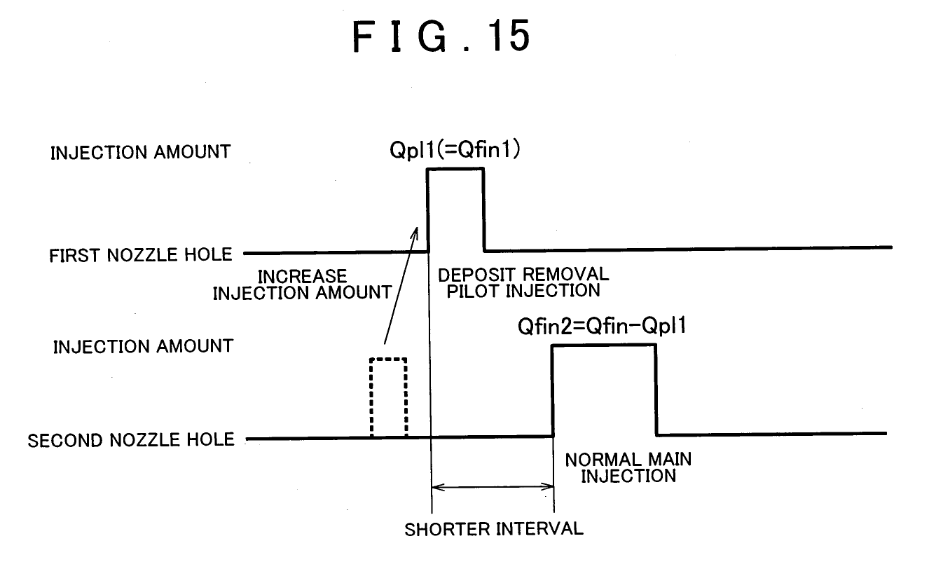

If the deposit removal flag is set ON, then the mode is switched from the normal injection to the deposit removal injection mode as shown in FIG. 14. In the injection pattern shown in FIG. 14, a pilot injection (“deposit removal pilot injection”) is performed through the first nozzle hole 9 to remove deposits therein, instead of the normal pilot injection through the second nozzle hole 10. Such a fuel injection through the first nozzle hole 9 removes deposits accumulated in the first nozzle hole 9. In FIG. 14, the injection timing of the deposit removal pilot injection is the same as the injection timing of the normal pilot injection shown in FIG. 13. In addition, the both injection amounts are the same. Thus, the relationship denoted by Qpl2=Qpl1 (=Qfin1) is established. Accordingly, the total injection amount Qfin2 through the second nozzle hole 10 is denoted by Qfin2=Qfin−Qpl1, where Qpl1 is the injection amount of the deposit removal pilot injection through the first nozzle hole 9. Thus, because the injection amount in one cycle of the deposit removal mode is the same as that in one cycle of the normal injection, the influence on the drivability is minimized.

Further, when the deposit removal pilot injection is performed through the first nozzle hole 9, instead of the normal pilot injection through the second nozzle hole 10, the time interval between the deposit removal pilot injection and the normal main injection may be set shorter than the time interval between the normal pilot injection and the normal main injection, and the injection amount of the deposit removal pilot injection may be increased. This is because the diameter of the second nozzle hole 10 is greater than the diameter of the first nozzle hole 9. More specifically, if the pilot injection is performed through the first nozzle hole 9, which is lightly loaded and has a smaller diameter, the exhaust degradation (emission degradation) may occur due to the increase in HC (hydrocarbon). The shortening of the time interval and the increase in the pilot injection amount may reduce such influences.

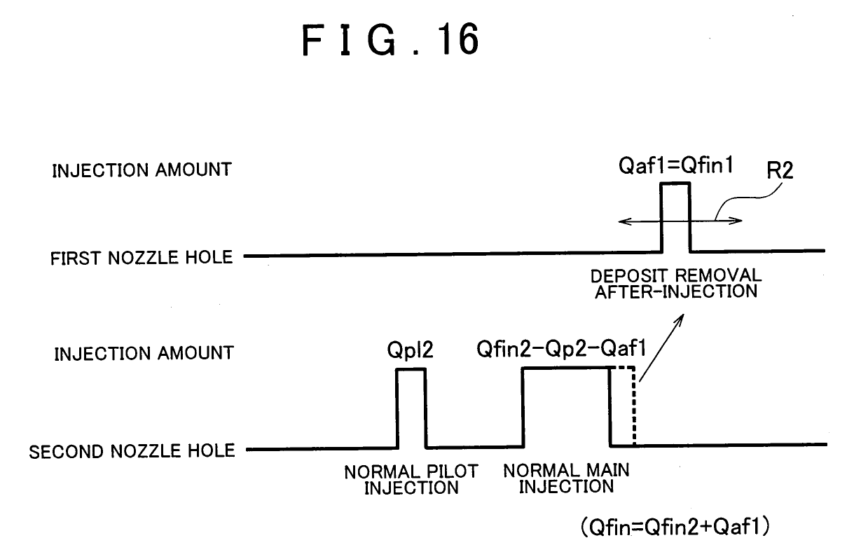

Alternatively, as shown in FIG. 16, a portion of the normal main injection through the second nozzle hole 10 in the normal injection may be separated (or reduced) and the separated (or reduced) amount of fuel may be injected through the first nozzle hole 9 as an after-injection to remove deposits therein (“deposit removal after-injection”). In other words, a portion Qaf1 of the normal main injection may be injected through the first nozzle hole 9. The injection timing of the deposit removal after-injection may be adjusted in the time range denoted by the reference numeral R2 in FIG. 16, in consideration of the influences by performing a portion of the main injection through the first nozzle hole 9, such as the degradation of drivability or emission, or the like.

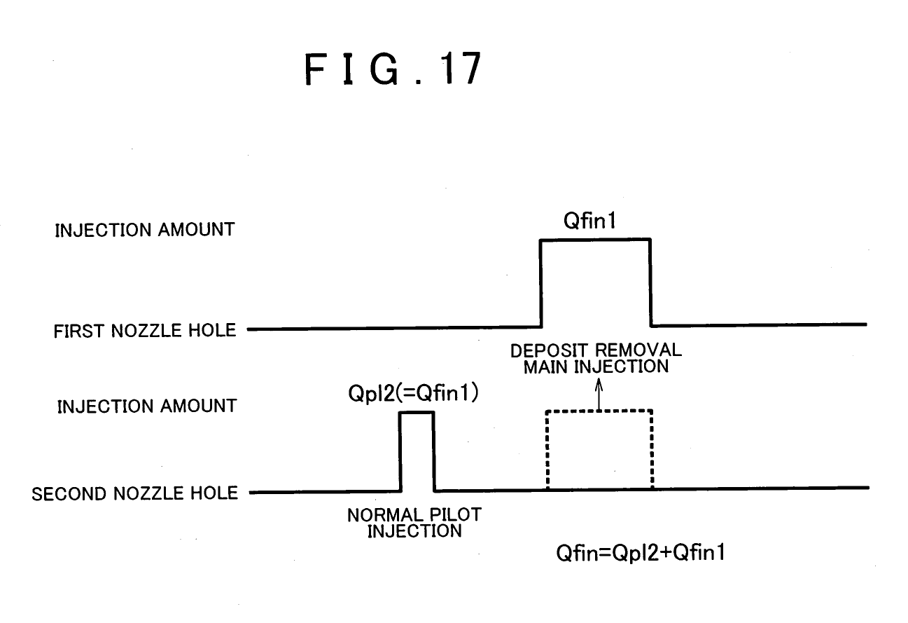

Further, as shown in FIG. 17, the entire normal main injection performed in the normal fuel injection through the second nozzle hole 10 may be replaced with a main injection through the first nozzle hole 9 to remove deposits therein (deposit removal main injection).

As described above, by injecting fuel through the first nozzle hole 9, the deposits accumulated in the first nozzle hole 9 are removed.

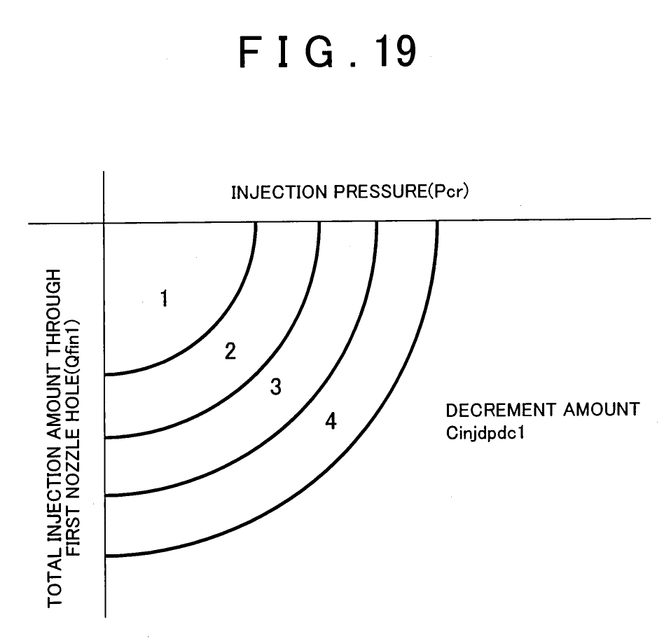

As described above, after the ECU 5 determines the conditions of the fuel injection to remove the deposits in the first nozzle hole, the control process proceeds to step S31, in which the ECU 5 determines the deposit decrement amount Cinjdpdc1, which is a deposit amount removed by the deposit removal fuel injection through the first nozzle hole. The deposit decrement amount Cinjdpdc1 is determined based on the map shown in FIG. 19. By using the map, the deposit decrement amount Cinjdpdc1 is obtained from the total fuel injection amount Qfin1 of the fuel injected through the first nozzle hole 9 to remove deposits therein and the fuel injection pressure Pcr. This is because, during the removal of the deposits accumulated in a nozzle Me, the recovery rate of the injection amount and the injection pressure of the fuel injected through the nozzle hole changes from the state where the atomization has been degraded by the accumulated deposits. In this embodiment, the four regions 1 to 4 are provided in the map shown in FIG. 19, and the deposit decrement amount Cinjdpdc1 corresponding to each region is determined.

In step S32, the deposit decrement amount Cinjdpdc1 determined in step S31 is subtracted from the current deposit amount Cinjdp1 to calculate a new deposit amount Cinjdp1.

Subsequently, the ECU 5 determines in step S33 whether the deposit amount Cinjdp1 calculated in step S32 is greater than a reference value H1′. The reference value H1′ is a value that defines criteria for determining whether the deposit removal fuel injection through the first nozzle hole 9 is stopped. If the determination in step S33 is affirmative, the control process returns to the beginning and repeats from step S1. On the contrary, if the determination in step S33 is negative, the control process proceeds to step S34, in which the deposit removal mode of the first nozzle hole is set OFF, and then returns to the beginning. The process repeats from step S1 thereafter.

Next, the case where the determination in step S21 is negative will be explained. If the injection mode is not the second mode (Injmd=2), the control process proceeds to step S41. If the determination in step S21 is negative, the injection mode is the third mode (Injmd=3). If it is determined that the injection mode is the third mode, the fuel is injected through both the first nozzle hole 9 and the second nozzle hole 10. The process of step S41 and the following perform fuel injection to remove deposits in each nozzle hole, in consideration of the case where the removal of deposits is insufficient even if the fuel is injected through both nozzle holes.

First, in step S41, the deposit decrement amount of the second nozzle hole 10 is calculated in the same manner as explained in step S13. Further, in step S42, the deposit amount in the second nozzle hole 10 is calculated in the same manner as explained in step S14.

Further, in step S43, the deposit decrement amount of the first nozzle hole 9 is calculated in the same manner as explained in step S31. Further, in step S44, the deposit amount in the first nozzle hole 9 is calculated in the same manner as explained in step S32.

In step S45, similarly to step S15, it is determined whether the deposit amount Cinjdp2 calculated in step S42 is greater than the reference value H1. The reference value H1 is a value that defines criteria for determining whether the deposit removal fuel injection through the second nozzle hole 10 is stopped. If the determination in step S45 is affirmative, the control process proceeds to step S46, in which the second nozzle hole deposit removal mode is set ON. On the other hand, if the determination in step S45 is negative, the control process proceeds to step S47, in which the second nozzle hole deposit removal mode is set OFF. After step S46 or step S47, the control process proceeds to step S48.

In step S48, similarly to step S34, it is determined whether the deposit amount Cinjdp1 calculated in step S44 is greater than the reference value H1′. The reference value H1′ is a value that defines criteria for determining whether the deposit removal fuel injection through the first nozzle hole 9 is stopped. If the determination in step S48 is affirmative, the control process proceeds to step S49, in which the first nozzle hole deposit removal mode is set ON. On the other hand, if the determination in step S48 is negative, the control process proceeds to step S50, in which the first nozzle hole deposit removal mode is set OFF. After step S49 or step S50, the control process returns to the beginning.

By performing the control as described above, the deposits accumulated in the first nozzle hole 9 and the second nozzle hole 10 are effectively removed, while the reduction in gas mileage or the exhaust degradation is reduced.

While some embodiments of the invention have been illustrated above, it is to be understood that the invention is not limited to details of the illustrated embodiments, but may be embodied with various changes, modifications or improvements, which may occur to those skilled in the art, without departing from the spirit and scope of the invention.

For example, in the flowchart shown in FIG. 3 or FIG. 4, the function Cinjdpin2=f(Ne, Qfin, Pcr) or Cinjdpin1=f(Ne, Qfin, Pcr) is used to calculate the deposit increment amount in step S5 and step S24; however, the deposit increment amount may be obtained by simply incrementing a counter by one. In other words, the deposit increment amount of the first nozzle hole 9 may be calculated by using the expression Cinjdpin1=Cinjdpin1+1, and the deposit increment amount of the second nozzle hole 10 may be calculated by using the expression Cinjdpin2=Cinjdpin2+1.

Further, in the above-described embodiment, the deposit decrement amount is calculated in step S12 or step S31 by using the map shown in FIG. 18 or FIG. 19. However, for example, the deposit decrement amount may be calculated by the following functions: Cinjdpdc1=f(Pcr, Qfin1)=C4×Pcr+C5×Qfin1, and Cinjdpdc2=f(Pcr, Qfin2)=C4×Pcr+C5×Qfin2, where C4 and C5 are fitness factors

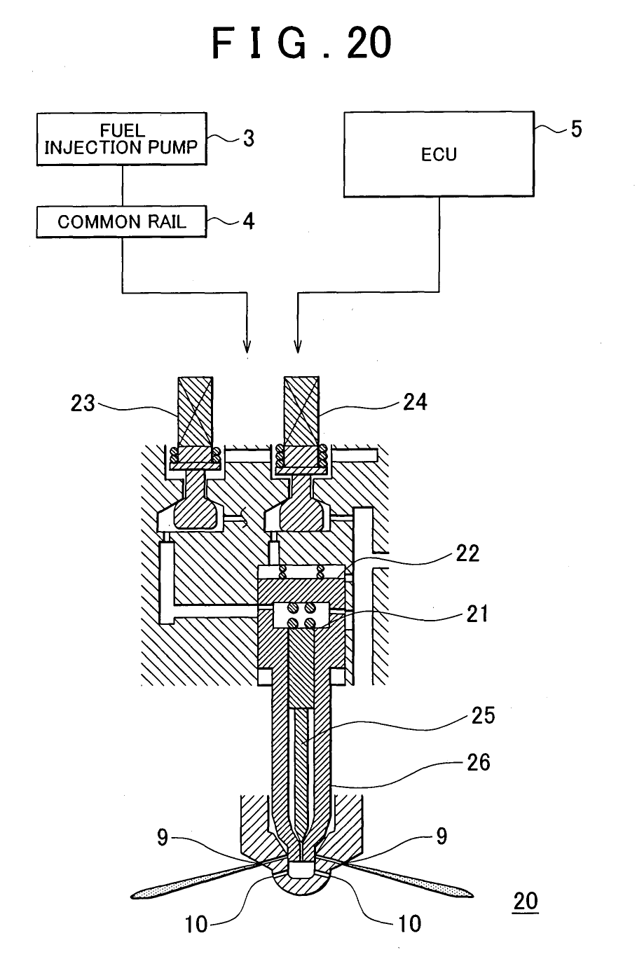

Further, instead of the fuel injection valve 2 used in the fuel injection device 1 of the above-described embodiment, the fuel injection valve 20 shown in FIG. 20 may be used. The fuel injection valve 20 is provided with two control chambers 21 and 22, respectively having actuators 23, 24 for hydraulic pressure control. The fuel injection valve 20 independently drives the inner needle 25 and the outer needle 26 to perform fuel injection control. Deposits may accumulate in the first nozzle hole 9 or the second nozzle hole 10 in the fuel injection valve 20; however, the accumulated deposit is effectively removed according to the present invention.

1. A fuel injection device comprising:
a fuel injection valve that injects fuel and is provided with a first nozzle hole and a second nozzle hole, which are controlled independently of each other to inject the fuel; and
a controller that controls a deposit removal fuel injection through the fuel injection valve in accordance with an amount of a deposit accumulated in at least one of the first nozzle hole and the second nozzle hole, the deposit removal fuel injection injecting fuel to remove the deposit.

2. The fuel injection device according to claim 1, wherein the deposit amount is determined in accordance with at least one of a deposit increment amount and a deposit decrement amount that are calculated based on an engine operation state.

3. The fuel injection device according to claim 1, wherein the deposit amount is determined in accordance with at least one of a deposit increment amount and a deposit decrement amount that are calculated from at least one of an ambient temperature of the fuel injection valve, an injection pattern, and a fuel flow rate in at least one of the first nozzle hole and the second nozzle hole.

4. The fuel injection device according to claim 2, wherein the deposit increment amount is calculated for each of the first nozzle hole and the second nozzle hole.

5. The fuel injection device according to claim 1, wherein the controller switches the fuel injection valve among a mode to inject fuel only through the first nozzle hole, a mode to inject fuel only through the second nozzle hole, and a mode to inject fuel though both the first nozzle hole and the second nozzle hole, and
the deposit removal fuel injection performed in one of the three modes is different from the deposit removal fuel injection performed in another of the three modes.

6. The fuel injection device according to claim 1 wherein the deposit removal fuel injection is performed as one of a main injection, a pilot injection and an after-injection.

7. The fuel injection device according to claim 6, wherein the main injection is performed through one of the first nozzle hole and the second nozzle hole, and the pilot injection or the after-injection is performed through the other of the first nozzle hole and the second nozzle hole.

8. The fuel injection device according to claim 7, wherein when a normal pilot injection and a normal main injection are performed through the first nozzle hole, the deposit removal fuel injection is performed as the pilot injection though the second nozzle hole, instead of the normal pilot injection.

9. The fuel injection device according to claim 8, wherein a time interval between the deposit removal fuel injection and the normal main injection is longer than a time interval between the normal pilot injection and the normal main injection.

10. The fuel injection device according to claim 7, wherein when a normal main injection is performed through the first nozzle hole, an amount of the normal main injection is reduced, and the deposit removal fuel injection is performed as the after-injection through the second nozzle hole, and an amount of the deposit removal fuel injection is substantially equal to the reduced amount of the normal main injection.

11. The fuel injection device according to claim 7, wherein when a normal pilot injection and a normal main injection are performed through the first nozzle hole, the deposit removal fuel injection is performed as the main injection through the second nozzle hole, instead of the normal main injection.

12. The fuel injection device according to claim 11, wherein, a time interval between the normal pilot injection and the normal main injection is shorter than a time interval between the normal pilot injection and the deposit removal fuel injection.

13. The fuel injection device according to claim 8, wherein a time interval between the deposit removal fuel injection and the normal main injection is shorter than a time interval between the normal pilot injection and the normal main injection.

14. The fuel injection device according to claim 13, wherein an amount of the deposit removal fuel injection is greater than an amount of the normal pilot injection.

15. The fuel injection device according to claim 13, wherein a diameter of the second nozzle is smaller than a diameter of the first nozzle.

16. The fuel injection device according to claim 9, wherein a diameter of the first nozzle hole is smaller than a diameter of the second nozzle hole.

17. The fuel injection device according to claim 3, wherein the deposit increment amount is calculated for each of the first nozzle hole and the second nozzle hole.
